(19) United States
(12) Patent Application Publication
(10) Pub. No.: US 2024/0135344 A1
(43) Pub. Date: Apr. 25, 2024

(54) SYSTEMS AND METHODS FOR PROCESSING STEAMS OF BALANCE TRANSFER DATA RECORDS

(71) Applicant: JPMORGAN CHASE BANK, N.A., New York, NY (US)

(72) Inventors: Varun PANDEY, Budd Lake, NJ (US); Sofia FREYDER, Mahwah, NJ (US); Dhruvkumar PATEL, Secaucus, NJ (US); Santoshkumar NAYAK, Edison, NJ (US); Varun AWASTHI, Jersey City, NJ (US); Praveen NAREDDY, Carrollton, TX (US); Leonard HAWKES, Paterson, NJ (US); Naganur HANAMANTGOUDA, West Windsor, NJ (US); Andres NATER ACOSTA, Brooklyn, NY (US); Ana GARCIA, East Hanover, NJ (US)

(21) Appl. No.: 18/049,433

(22) Filed: Oct. 24, 2022

(51) Int. Cl. G06Q 20/10

(52) U.S. Cl. CPC G06Q 20/102; G06Q 20/108

(57) ABSTRACT

A method may include a producer application receiving balance transfer request data, formatting the balance transfer request data into a plurality of balance transfer data records, and streaming the plurality of balance transfer data records to an event streaming platform. A method may include an event streaming platform formatting the plurality of balance transfer data records into a partition and sending the balance transfer data records in a sequential order to a consuming application. A method may include a consuming application sending a first part of the balance transfer data records to a real-time payment network for settlement of a payment indicated in the first part of the balance transfer data records and sending a second part of the balance transfer data records to a posting application for posting to an electronic account balance ledger.

### BACKGROUND

### 1. Field of the Invention

Aspects generally relate to systems and methods for processing streams of balance transfer data records.

### 2. Description of the Related Art

Real-time payments (RTP) are payments that are initiated and settled nearly instantaneously. A real-time payment network, (sometimes referred to as “real-time payment rails”) is a network infrastructure that facilitates real-time payments. Often, real-time payment networks provide continuous access to the provided payment service (i.e., the network is available 24 hours a day, and 365 days a year). RTP provides immediate funds availability and real time settlement, payments finality, instant payment confirmation, and integrated information flows—all within seconds. In order to process and display corresponding internal records at the same rate that RTP networks process corresponding payment transactions, however, issuing organizations must implement enhancements to their internal technical infrastructures.

### SUMMARY

In some aspects, the techniques described herein relate to a method including: receiving, at a producer application, balance transfer request data; formatting, by the producer application, the balance transfer request data into a plurality of balance transfer data records; streaming, by the producer application, the plurality of balance transfer data records to an event streaming platform; formatting, by the event streaming platform, the plurality of balance transfer data records into a partition, wherein the partition formats the balance transfer data records in a sequential order; sending, by the event streaming platform, the balance transfer data records in the sequential order to a consuming application; sending, by the consuming application, a first part of one of the plurality of balance transfer data records to a real-time payment network, wherein the real-time payment network initiates settle of a payment indicated in the first part of the one of the plurality of balance transfer data records; sending, by the consuming application, a second part of the one of the plurality of balance transfer data records to a posting application; and posting, by a posting application, a hard post of the payment indicated in the first part of the one of the plurality of balance transfer data records to a account ledger.

In some aspects, the techniques described herein relate to a method, wherein at least part of the balance request transfer data is received from a public-facing web interface.

In some aspects, the techniques described herein relate to a method, wherein the producer application is one instance of a plurality of producer applications.

In some aspects, the techniques described herein relate to a method, wherein the partition is associated with a topic.

In some aspects, the techniques described herein relate to a method, wherein the consuming application subscribes to the topic.

In some aspects, the techniques described herein relate to a method, wherein the event streaming platform includes an event streaming server cluster.

In some aspects, the techniques described herein relate to a method, wherein the event streaming server cluster hosts a plurality of partitions, and wherein the partition is one of the plurality of partitions.

In some aspects, the techniques described herein relate to a system including: a producer application; an event streaming platform; a consuming application; and a posting application; wherein the system is configured to: receive, at a producer application, balance transfer request data; format, by the producer application, the balance transfer request data into a plurality of balance transfer data records; stream, by the producer application, the plurality of balance transfer data records to an event streaming platform; format, by the event streaming platform, the plurality of balance transfer data records into a partition, wherein the partition formats the balance transfer data records in a sequential order; send, by the event streaming platform, the balance transfer data records in the sequential order to a consuming application; send, by the consuming application, a first part of one of the plurality of balance transfer data records to a real-time payment network, wherein the real-time payment network initiates settle of a payment indicated in the first part of the one of the plurality of balance transfer data records; send, by the consuming application, a second part of the one of the plurality of balance transfer data records to a posting application; and post, by a posting application, a hard post of the payment indicated in the first part of the one of the plurality of balance transfer data records to a account ledger.

In some aspects, the techniques described herein relate to a system, wherein at least part of the balance request transfer data is received from a public-facing web interface.

In some aspects, the techniques described herein relate to a system, wherein the producer application is one instance of a plurality of producer applications.

In some aspects, the techniques described herein relate to a system, wherein the partition is associated with a topic.

In some aspects, the techniques described herein relate to a system, wherein the consuming application subscribes to the topic.

In some aspects, the techniques described herein relate to a system, wherein the event streaming platform includes an event streaming server cluster.

In some aspects, the techniques described herein relate to a system, wherein the event streaming server cluster hosts a plurality of partitions, and wherein the partition is one of the plurality of partitions.

In some aspects, the techniques described herein relate to a non-transitory computer readable storage medium, including instructions stored thereon, which instructions when read and executed by one or more computers cause the one or more computers to perform steps including: receiving, at a producer application, balance transfer request data; formatting, by the producer application, the balance transfer request data into a plurality of balance transfer data records; streaming, by the producer application, the plurality of balance transfer data records to an event streaming platform; formatting, by the event streaming platform, the plurality of balance transfer data records into a partition, wherein the partition formats the balance transfer data records in a sequential order; sending, by the event streaming platform, the balance transfer data records in the sequential order to a consuming application; sending, by the consuming application, a first part of one of the plurality of balance transfer data records to a real-time payment network, wherein the real-time payment network initiates settle of a payment indicated in the first part of the one of the plurality of balance transfer data records; sending, by the consuming application, a second part of the one of the plurality of balance transfer data records to a posting application; and posting, by a posting application, a hard post of the payment indicated in the first part of the one of the plurality of balance transfer data records to a account ledger.

In some aspects, the techniques described herein relate to a non-transitory computer readable storage medium, wherein at least part of the balance request transfer data is received from a public-facing web interface.

In some aspects, the techniques described herein relate to a non-transitory computer readable storage medium, wherein the producer application is one instance of a plurality of producer applications.

In some aspects, the techniques described herein relate to a non-transitory computer readable storage medium, wherein the partition is associated with a topic.

In some aspects, the techniques described herein relate to a non-transitory computer readable storage medium, wherein the consuming application subscribes to the topic.

In some aspects, the techniques described herein relate to a non-transitory computer readable storage medium, wherein the event streaming platform includes an event streaming server cluster.

### BRIEF DESCRIPTION OF THE DRAWINGS

FIG. 1 is a block diagram of a system for processing streams of balance transfer data records, in accordance with aspects.

FIG. 2a is a block diagram of a system for processing streams of balance transfer data records, in accordance with aspects.

FIG. 2b is a block diagram of a system for processing streams of balance transfer data records, in accordance with aspects.

FIG. 3 is a flow chart of steps for processing streams of balance transfer data records, in accordance with aspects.

FIG. 4 is a block diagram of a computing device for implementing certain aspects of the present disclosure.

### DETAILED DESCRIPTION

Aspects generally relate to systems and methods for processing streams of balance transfer data records.

As RTP networks become more commonplace, opportunities for use cases are continuously being innovated. One such use case involves leveraging RTP networks to provide near instantaneous balance transfers from a first payment product to a second payment product, where the first and second payment products originate with different issuing organizations. Payment product issuing organizations, such as financial institutions, issue payment products such as credit cards and credit accounts to consumers. These payment products generally define account attributes such as a credit limit, an interest rate, and a current balance. Balances may be transferred between payment products, but use of conventional payment transfer networks require several days before balance-transfer payments are settled and balances are reflected as transferred at interfaces of the issuing organization.

While RTP networks can advance payment clearance and posting to near-instantaneous timeframes, technical enhancements to backend processing infrastructures of issuing organizations must be made in order to reflect electronic balance transfers concurrently and accurately to customers within the same timeframe as RTP transfers are settled and cleared. Systems and methods disclosed herein provide for performance enhancements to the technical infrastructure of issuing organizations using an event streaming platform and architecture and real-time, event driven applications that can continually produce and consume streams of balance transfer data records, prepare the balance transfer data records for transmission to an RTP network, and update and display internal systems and records in near-real time. Records may be replicated and partitioned so that a high volume of users can use the application simultaneously with no lag in performance and can experience near-real time balance updates for accounts to which balances are transferred to. Such near-real time updates would not be achievable with conventional architectures.

Often, consumers wish to take advantage of new or different payment products in order to take advantage of better terms, such as better interest rates on current balances, offered with new/different payment products. Taking advantage of new and better terms often requires the consumer to initiate a balance transfer from an existing payment product to a new or different payment product. As used herein, the term “payment product” refers not only to credit accounts, but also to any loan account, and the systems and methods disclosed herein can be applied in the same or a similar manner to any such debt account.

In accordance with aspects, a consumer may interact with an electronic interface of an issuing organization in order to provide information necessary to provision a new payment product. For instance, a consumer may access an issuing organization's website via a user device and provide personal and other information necessary to provision a new payment product via a web form. Alternatively, a consumer may interact with an issuing organization's electronic interfaces in order to initiate a balance transfer to an existing payment product. In either case, if a balance transfer to the new or existing payment product (referred to herein as a “target payment product”) is available to the consumer, then the consumer may also provide details such as an account number for an existing payment product with a current balance, a monetary balance transfer amount, and the name of the issuing organization that issued the payment product from which the balance transfer amount will be transferred. As used herein, the term “transfer payment product” refers to an existing payment product from which a balance is or will be transferred to a target payment product.

In accordance with aspects, a consumer may interact with an issuing organization's web-based interface (e.g., a website) and provide balance transfer information to the issuing organization via the web interface (e.g., via website forms). The balance transfer information may include an account number of a transfer payment product, a monetary amount to transfer from the transfer payment product to the target payment product, a name of the issuing organization that issued the transfer payment product, and an identifier of the target account associated with the target payment product. Some of the balance transfer information may be generated and stored by the issuing organization, such as an identifier of the target account, and will not need to be input by the consumer. Other information may be included as is appropriate or desired. This information may be received from the web interface and/or from one or more backend systems for processing by a backend application of the issuing organization's technology infrastructure.

In accordance with aspects, certain processing of balance transfer requests may be carried out via a distributed event streaming platform (e.g., Apache Kafka®) for handling of associated events in the form of real time and near-real time streaming data to/from streaming data pipelines and/or streaming applications. Streaming data is data that is continuously generated by a data source. An event streaming platform can receive streaming data from multiple sources and process the data sequentially and incrementally. Event streaming platforms can be used in conjunction with real time and near-real time streaming data pipelines and streaming applications. For example, an event streaming platform can ingest and store streaming data from the data pipeline or streaming application and provide the data to an application that processes the streaming data. A streaming event platform may include partitioned commit logs (each, an ordered sequence of records) to store corresponding streams of records. The logs are divided into partitions, and a subscriber can subscribe to a “topic” that is associated with a partition, and thereby receive all records stored at the partition (e.g., as passed to the subscriber in real time by the platform, or after a predefined delay in order to allow other processing to take place).

Event streaming platforms offer highly accurate and highly available services for processing continuous data streams, such as a high volume of incoming balance transfer requests. Records may be replicated and partitioned so that a high volume of users can use the application simultaneously with no lag in performance. Further, an event streaming platform can maintain accuracy in the order of received data records' occurrences. Accordingly, customed-engineered event streaming platforms offer ideal enhancements over conventional systems with respect to continuously received balance transfer requests.

An event streaming platform may provide a producer application that publishes a stream of records to a topic via an exposed producer API, and a consumer API that a consuming application can use to subscribe to topics and thereby receive the record stream associated with that topic. An event streaming platform may also publish other APIs with necessary or desired functionality. For instance, an event streaming platform may include an API that facilitates persistent storage of streamed partition data in a database or other appropriate data store.

In accordance with aspects, a producer application may receive the incoming balance transfer requests from an external facing interface and/or from other internal systems. The producer application may be a real-time event driven application in that it processes the incoming balance transfer requests in real time as they are received into a stream of data records and sends them via a producer API to an event streaming server cluster. The event streaming server cluster receives the balance transfer data records and formats them into partitions associated with a topic. For instance, a topic may be identified as a “transfer” or “XFR” topic, and all received balance transfer data records may be written to the XFR topic of the event streaming server cluster as they are received and transmitted by the producer application.

An event streaming server cluster may receive balance transfer data records from one or more producer applications. Multiple producer applications may be distributed across various geographic areas and across various data centers to provide fault tolerance and adequate throughput. Likewise, each producer application may transmit balance transfer data records to the event streaming server cluster, and the event streaming server cluster may receive and process the data records with a plurality of cluster servers. Each server in the event streaming server cluster may host an instance of a named topic (such as a “XFR” topic) that stream-processes the incoming balance transfer data records into a plurality of partitions. A given server of the multiple servers of the event streaming server cluster may write incoming data records to a resident partition of a topic and may replicate the partitions across the multiple servers of the cluster for redundancy and enhanced efficiency. The data records may be written sequentially, as received, so that the streaming order is maintained.

In accordance with aspects, one or more consuming applications may subscribe to a XFR topic, and may receive, from the event streaming server cluster, balance transfer data records in the sequential order in which they are added to the partitions of the topic. As a consuming application receives data records from the event streaming server cluster, the consuming application can appropriately format the received balance transfer data records and call an external API gateway in communication with a RTP network to pass the balance transfer data records to the RTP network for payment processing and clearance.

Additionally, a consuming application may transmit received balance transfer data records to posting systems of the issuing organization. This may be done simultaneously, or substantially simultaneously as transmission of the data records to the external API gateway. Because of the RTP networks near-instantaneous settlement of payments, waiting for notifications of corresponding payment clearance from the payment network is not required before an issuing organization's internal posting ledger may be updated. This is an enhancement over conventional balance transfer systems in that accuracy is greatly improved through the elimination of persistent-storage, retrieval and modification steps for the balance transfer data records previously required while payments clear over several days using traditional payment networks. This is realized through the elimination of soft posts (i.e., holds, or “pending” transactions to payment product account ledgers. A hard (i.e., non-pending) post may simply be made by the ledger system, with no further steps needed.

Accordingly, a consuming application may be configured, for each received balance transfer data record, to update an account ledger application with a hard post to the relevant account. The hard post can be reflected in near-real time to the consumer that requested the balance transfer via an electronic (e.g., a web-based) account ledger. That is, the consumer may immediately log in to the electronic account ledger and view the updated balance that reflects the requested transfer. Additionally, the consumer may receive various electronic communications (e.g., an email, an SMS message, a push notification to a mobile application, etc.) nearly instantaneously after submitting a balance transfer request.

In accordance with aspects, a fraud detection service may process all incoming requests for balance transfers to determine fraudulent balance transfer requests. A fraud detection service may include a machine learning (“ML”) algorithm that has been trained to detect fraudulent balance transfer requests. A fraud detection service may also include algorithmic and/or policy-based fraud-detection methods.

In accordance with aspects, a fraud detection service may be implemented inline with the event steaming platform and may subscribe to a transfer topic as a consuming application. Consuming applications that process balance transfer data records for clearance and posting may delay consumption of the data records until after a fraud detection engine has processed the data records. In other aspects, a fraud detection service may be configured as a producer application in that it provides a stream of verified balance transfer records to an event streaming server cluster as a “verified transaction topic.” A verified transaction topic may receive and partition balance transfer data records that have been verified by a fraud detection service as legitimately initiated by a valid consumer that is a customer of the issuing organization (i.e., not a fraud actor).

As noted above, an event streaming platform may be configured to persistently store data records for subsequent uses. In accordance with aspects, data records that are persistently stored in a data store may be used to recursively train ML-based fraud detection services, such that the ML algorithm is constantly trained on timely and relevant balance transfer request data.

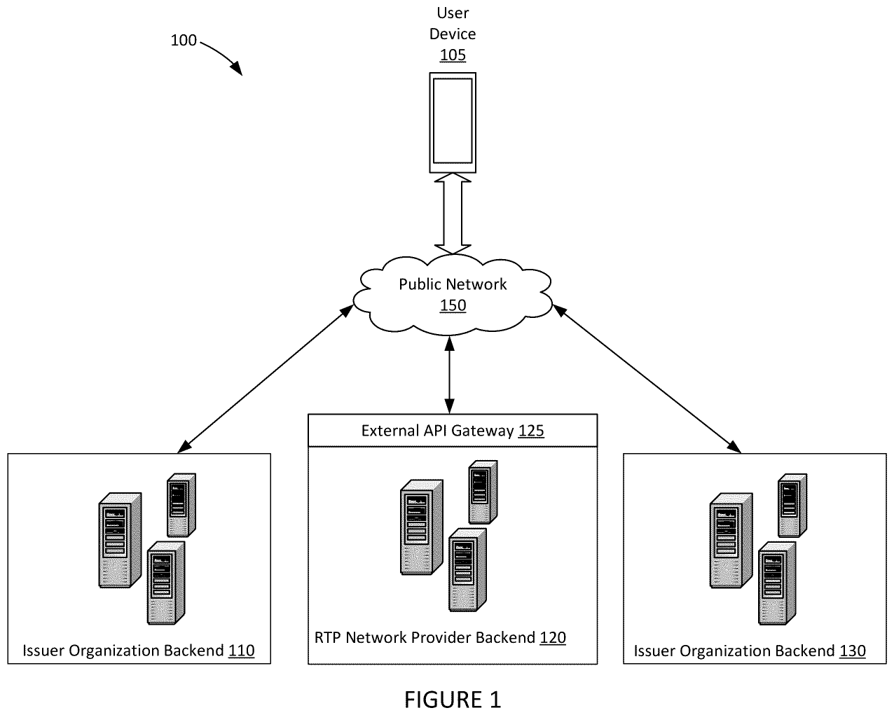

FIG. 1 is a block diagram of a system for processing streams of balance transfer data records, in accordance with aspects. System 100 includes issuing organization backend 110, issuing organization backend 130, and RTP network provider backend 120. Additionally, FIG. 1 includes external API gateway 125, public network 150, and user device 105.

In accordance with aspects, issuing organization backend 110 and issuing organization backend 130 represent the backend technology infrastructures of payment product issuing organizations. RTP network provider backend 120 represents the backend technology infrastructure of a payment network providing organization. These infrastructures include servers, computers, software applications, computer network mediums, and computer networking hardware and software for providing electronic services based on computer software applications executing on requisite hardware. Exemplary hardware and software include webservers, application servers, communication servers such as email servers and SMS servers, network routers, switches and firewalls, custom-developed software applications (including hardware to execute such applications on), etc.

In accordance with aspects, issuing organization backend 110, issuing organization backend 130, and RTP network provider backend 120 may each include a private network that facilitates operative communication among system components included therein. Additionally, these backend infrastructures may be configured to interface with public network 150 in order to facilitate communications with hardware and software components, and other backend infrastructures that are outside of each respective backend infrastructure. Public network 150 may be a public network such as the Internet.

Issuing organization backend 110, issuing organization backend 130, RTP network provider backend 120 and user device 105 may each be communicatively coupled to public and private networks with appropriate hardware and software. For instance, user device 105 may include a wired or wireless network interface card (NIC) that interfaces with public network 150 and is configured with appropriate communication protocols. Likewise, issuing organization backend 110, issuing organization backend 130, and RTP network provider backend 120 may include hardware (NICs, switches, routers, etc.) configured with appropriate protocols for intercommunication across public network 150.

At the application layer, the various components of FIG. 1 may be configured to communicate via any suitable method. For instance, communication may be configured via various application programming interfaces (APIs). APIs may be internal APIs (i.e., only accessible within the bounds of a private communication network), or they may be external facing APIs. External API gateway 125 may be a partner API that requires access rights from the providing party (e.g., RTP network provider backend 120) in order to gain access and facilitate operative communication. External API gateway 125 may be accessible to partner organizations, such as issuing organization backend 110 and issuing organization backend 130, via public network 150. APIs, whether internal or external, may be based on any suitable API architecture. Exemplary API architectures and/or protocols include SOAP (Simple Object Access Protocol), XML-RPC, REST (Representational State Transfer), or the like.

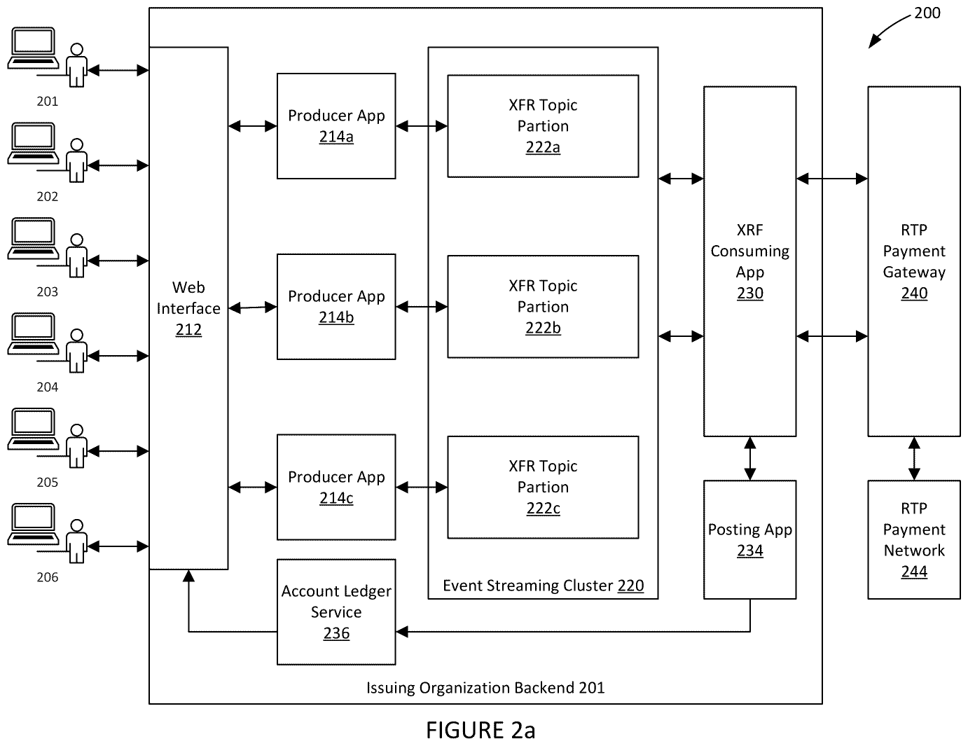

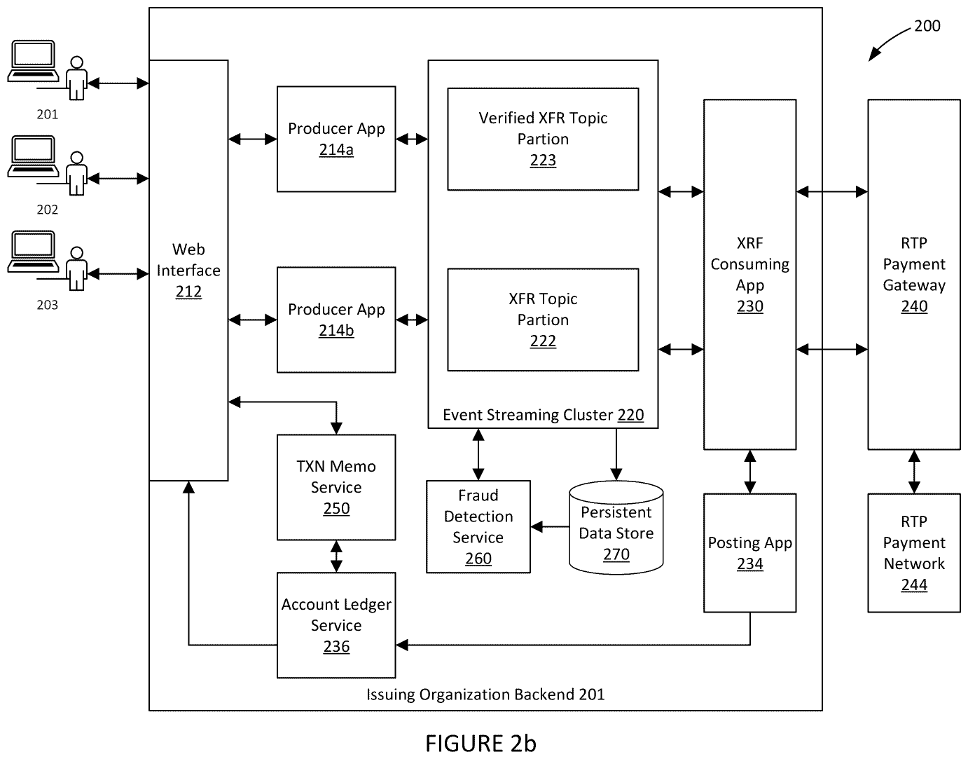

FIG. 2a is a block diagram of a system for processing streams of balance transfer data records, in accordance with aspects. System 200 includes user devices 201-206. User devices 201-206 are used by consumers of services offered by issuing organization backend 201. While user devices 201-206 are depicted, it is contemplated that user devices 201-206 may represent a large number of user devices—on the order of up to multiple millions of devices, or more.

System 200 additionally includes issuing organization backend 201. Issuing organization backend 201 includes web interface 212. Web interface 212 may be hosted by a public-network facing web server of issuing organization backend 201. Web interface 212 may be replicated across several web servers for redundancy and adequate throughput for serving a high volume of user devices. Web interface 212 may receive balance transfer requests from user devices 201-206. Web interface 212 may pass the received balance transfer requests to one or more producer applications for formatting as balance transfer data records.

With continued reference to FIG. 2a, included are producer application 214a, producer application 214b, and producer application 214c (each labeled a “producer app” in FIG. 2a. Producer apps 214a-c may be configured as real-time event driven applications that processes the incoming balance transfer requests from web interface 212 in real time into a stream of data records. Producer apps 214a-c may send the stream of data records to an event streaming server cluster. Producer apps 214a-c may be instances of the same producer application executed on different physical servers, and that serve different geographical locations, or that are allocated according to other considerations. While producer apps 214a-c are shown in FIG. 2a, it is contemplated that any number of instances of a relevant producer app may be provided by an issuing organization as is necessary or desirable to provide adequate producer application services for streaming incoming balance transfer requests.

In accordance with aspects a producer application may receive web-form data from a web interface and from other internal systems/service, and format the received data into a data record that is compatible for processing by an event streaming platform/server cluster. Accordingly, a producer application may receive a balance transfer request that includes an account number of a transfer payment product, a transfer amount (denominated in a currency, such as U.S. dollars), a name of the issuing institution that issued the transfer payment product, an account identifier of the associated target payment product, a transaction ID associated with the requested balance transfer (which may be randomly generated by internal systems), an account number of the target payment product associated with target payment product, and specification of a topic to transmit the data record to. In some aspects, a producer application may be pre-configured to send all received data to a particular topic and partition. The producer app may generate, from the received balance transfer request data, a balance transfer request data record and transmit the balance request data record to a corresponding topic/partition of an event streaming server cluster.

Event streaming cluster 220 is a cluster of servers in an event streaming platform. Event streaming cluster 220 includes XFR topic partition 222a, XFR topic partition 222b, and XFR topic partition 222c. “XFR,” as used herein, is an abbreviation for “transfer.” Event streaming cluster 220 receives balance transfer data records, formats them into partitions in the corresponding topic, and publishes the topics for consumption of the corresponding partitions by consuming applications. Event streaming cluster 220 may be comprised of as many physical servers as is necessary or desirable to meet redundancy and throughput needs. Event streaming cluster 220 may be configured such that each partition is located on a separate physical server in the cluster. Event streaming cluster 220 may provide the partitioned data to consuming applications in the sequential order in which it was received.

In accordance with aspects. A transfer consuming application may subscribe to a topic published by an event steaming server cluster and consume data records from the partitions of topics that the transfer consuming application subscribes to. With reference to FIG. 2a, XFR consuming app 230 subscribes to the XFR topic and consumes balance transfer data records from XFR topic partitions 222a-c. XFR consuming app 230 consumes and process balance transfer records in the sequential order they are received by event streaming cluster 220.

XFR consuming app 230 formats the received balance transfer data records as parameterized data that is compatible with API method calls from RTP payment gateway 240. That is, after receiving a balance transfer data record, XFR consuming app 230 calls an exposed method provided by RTP payment gateway 240 and includes the parameterized balance transfer data as parameters of the called method. RTP payment gateway 240 then processes the parameterized balance transfer data as a payment on RTP payment network 244. RTP payment gateway 240 may be configured as an external API gateway.

Additionally, XFR consuming app 230 formats the received balance transfer data for transmission to posting app 234. Posting app 234 may also expose an API and corresponding methods that receive balance transfer data records, or parts thereof, as parameterized data and process the balance transfer data records as hard posts to account ledger service 236. That is, XFR consuming app 230 may transmit the balance amount, an identifier of the target account, and the name of the issuing organization of the relevant transfer payment product to posting app 234 and posting app 234 may update ledger service 236. Ledger service 236 may be viewable by user devices 201-202 (and users thereof) via web interface 212.

FIG. 2b is a block diagram of a system for processing streams of balance transfer data records, in accordance with aspects. FIG. 2b includes TXN memo service 250, fraud detection service 260, and persistent data store 270. In accordance with aspects, TXN memo service 250 may be configured to receive balance transfer requests and/or data records and generate a memo transaction to update an account associated with the balance transfer request for a target payment product. That is, TXN memo service 250 may post a memo transaction including a monetary amount to account ledger service 236, for the account associated with the target payment product that is associated with the received balance transfer request. The memo transaction may include the account identifier for the transfer, the balance transfer amount, and a transaction ID. In accordance with aspects, when posting app 234 updates account ledger service 236 with a hard post associated with corresponding balance transfer data records that have been sent for processing by RTP payment network 244, account ledger service 236 may update the ledger record having a memo transaction with a corresponding account ID, balance transfer amount and transaction ID. The account identifier and/or the transaction identifier may be used as lookup keys by posting app 234 to identify the correct account and record for which to update with the hard post.

With continued reference to FIG. 2b, Fraud detection service 260 may be in operative communication with event streaming cluster 220 and may be configured as a consuming application that subscribes to XFR topic partition 222 and receives balance transfer data records from XFR topic partition 222. Fraud detection service 260 may process received balance transfer data records and process them as described, above, to determine a likelihood that a given balance transfer request is fraudulent. Further, fraud detection service 260 may be configured as a producer app that produces a stream of verified balance transfer data records as a stream for verified XFR topic partition 223. In accordance with aspects, XFR consuming app 230 may subscribe to verified XFR topic partition 223 so that XFR consuming app 230 only receives verified balance transfer data records to send for processing by RTP payment network 244 via RTP payment gateway 240.

In accordance with aspects, event streaming cluster 220 may persist balance transfer data records to persistent data store 270. Persistent data store 270 may also receive data related to balance transfer requests from other sources, and such data may indicate whether a relevant balance transfer request was fraudulent of legitimate. Fraud detection service 260 may be recursively trained on the information persisted in persistent data store 270, from time to time, so that ML algorithms included therein have training on timely and relevant records.

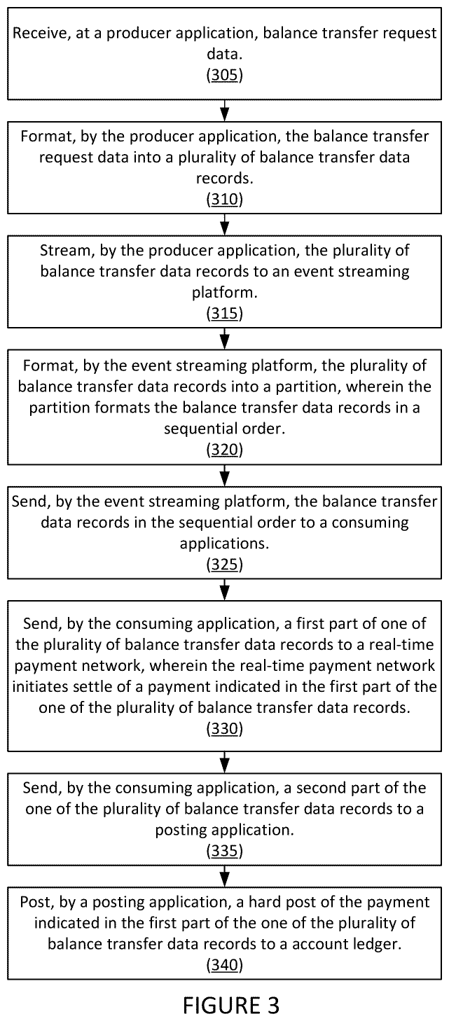

FIG. 3 is a flow chart of steps for processing streams of balance transfer data records, in accordance with aspects.

Step 305 includes receiving, at a producer application, balance transfer request data.

Step 310 includes formatting, by the producer application, the balance transfer request data into a plurality of balance transfer data records.

Step 315 includes streaming, by the producer application, the plurality of balance transfer data records to an event streaming platform.

Step 320 includes formatting, by the event streaming platform, the plurality of balance transfer data records into a partition, wherein the partition formats the balance transfer data records in a sequential order.

Step 325 includes sending, by the event streaming platform, the balance transfer data records in the sequential order to a consuming application.

Step 330 includes sending, by the consuming application, a first part of one of the plurality of balance transfer data records to a real-time payment network, wherein the real-time payment network initiates settle of a payment indicated in the first part of the one of the plurality of balance transfer data records.

Step 335 includes sending, by the consuming application, a second part of the one of the plurality of balance transfer data records to a posting application.

Step 340 includes posting, by a posting application, a hard post of the payment indicated in the first part of the one of the plurality of balance transfer data records to a account ledger.

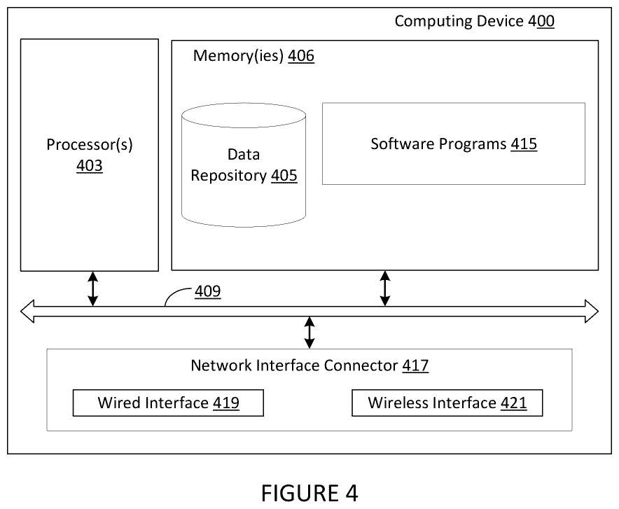

FIG. 4 is a block diagram of a computing device for implementing certain aspects of the present disclosure. FIG. 4 depicts exemplary computing device 400. Computing device 400 may represent the system components described herein. For example, system components such as an event streaming server cluster, a producer application, a consuming application, a posting application, etc., may include components and configurations, or be executed on hardware, like, or similar to, computing device 400. Computing device 400 includes a processor 403 coupled to a memory 406. Memory 406 may include volatile memory. The processor 403 executes computer-executable program code stored in memory 406, such as software programs 415. Software programs 415 may include one or more of the logical steps disclosed herein as a programmatic instruction, which can be executed by processor 403. Memory 406 may also include data repository 405, which may be nonvolatile memory for data persistence. The processor 403 and the memory 406 may be coupled by a bus 409. In some examples, the bus 409 may also be coupled to one or more network interface connectors 417, such as wired network interface 419, and/or wireless network interface 421. Computing device 400 may also have user interface components, such as a screen for displaying graphical user interfaces and receiving input from the user, a mouse, a keyboard and/or other input/output components (not shown).

The various processing steps and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a micro-processor and/or in the form of programmed electronic circuitry.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one aspect, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, aspects of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications or equivalent arrangements.

1. A method comprising:
receiving, at a producer application, balance transfer request data;
formatting, by the producer application, the balance transfer request data into a plurality of balance transfer data records;
streaming, by the producer application, the plurality of balance transfer data records to an event streaming platform;
formatting, by the event streaming platform, the plurality of balance transfer data records into a partition, wherein the partition formats the balance transfer data records in a sequential order;
sending, by the event streaming platform, the balance transfer data records in the sequential order to a consuming application;
sending, by the consuming application, a first part of one of the plurality of balance transfer data records to a real-time payment network, wherein the real-time payment network initiates settle of a payment indicated in the first part of the one of the plurality of balance transfer data records;
sending, by the consuming application, a second part of the one of the plurality of balance transfer data records to a posting application; and
posting, by a posting application, a hard post of the payment indicated in the first part of the one of the plurality of balance transfer data records to a account ledger.

2. The method of claim 1, wherein at least part of the balance request transfer data is received from a public-facing web interface.

3. The method of claim 1, wherein the producer application is one instance of a plurality of producer applications.

4. The method of claim 1, wherein the partition is associated with a topic.

5. The method of claim 4, wherein the consuming application subscribes to the topic.

6. The method of claim 1, wherein the event streaming platform comprises an event streaming server cluster.

7. The method of claim 6, wherein the event streaming server cluster hosts a plurality of partitions, and wherein the partition is one of the plurality of partitions.

8. A system comprising:
a producer application;
an event streaming platform;
a consuming application; and
a posting application;
wherein the system is configured to:
receive, at a producer application, balance transfer request data;
format, by the producer application, the balance transfer request data into a plurality of balance transfer data records;
stream, by the producer application, the plurality of balance transfer data records to an event streaming platform;
format, by the event streaming platform, the plurality of balance transfer data records into a partition, wherein the partition formats the balance transfer data records in a sequential order;
send, by the event streaming platform, the balance transfer data records in the sequential order to a consuming application;
send, by the consuming application, a first part of one of the plurality of balance transfer data records to a real-time payment network, wherein the real-time payment network initiates settle of a payment indicated in the first part of the one of the plurality of balance transfer data records;
send, by the consuming application, a second part of the one of the plurality of balance transfer data records to a posting application; and
post, by a posting application, a hard post of the payment indicated in the first part of the one of the plurality of balance transfer data records to a account ledger.

9. The system of claim 8, wherein at least part of the balance request transfer data is received from a public-facing web interface.

10. The system of claim 8, wherein the producer application is one instance of a plurality of producer applications.

11. The system of claim 8, wherein the partition is associated with a topic.

12. The system of claim 11, wherein the consuming application subscribes to the topic.

13. The system of claim 8, wherein the event streaming platform comprises an event streaming server cluster.

14. The system of claim 13, wherein the event streaming server cluster hosts a plurality of partitions, and wherein the partition is one of the plurality of partitions.

15. A non-transitory computer readable storage medium, including instructions stored thereon, which instructions when read and executed by one or more computers cause the one or more computers to perform steps comprising:
receiving, at a producer application, balance transfer request data;
formatting, by the producer application, the balance transfer request data into a plurality of balance transfer data records;
streaming, by the producer application, the plurality of balance transfer data records to an event streaming platform;
formatting, by the event streaming platform, the plurality of balance transfer data records into a partition, wherein the partition formats the balance transfer data records in a sequential order;
sending, by the event streaming platform, the balance transfer data records in the sequential order to a consuming application;
sending, by the consuming application, a first part of one of the plurality of balance transfer data records to a real-time payment network, wherein the real-time payment network initiates settle of a payment indicated in the first part of the one of the plurality of balance transfer data records;
sending, by the consuming application, a second part of the one of the plurality of balance transfer data records to a posting application; and
posting, by a posting application, a hard post of the payment indicated in the first part of the one of the plurality of balance transfer data records to a account ledger.

16. The non-transitory computer readable storage medium of claim 15, wherein at least part of the balance request transfer data is received from a public-facing web interface.

17. The non-transitory computer readable storage medium of claim 15, wherein the producer application is one instance of a plurality of producer applications.

18. The non-transitory computer readable storage medium of claim 15, wherein the partition is associated with a topic.

19. The non-transitory computer readable storage medium of claim 18, wherein the consuming application subscribes to the topic.

20. The non-transitory computer readable storage medium of claim 15, wherein the event streaming platform comprises an event streaming server cluster.
